(19) United States
(12) Patent Application Publication
(10) Pub. No.: US 2004/0126638 A1
(43) Pub. Date: Jul. 1, 2004

(54) Layered proton exchange membrane and method for preparing the same

(76) Inventors: Jong-Pyng Chen, Hsinchu (TW); Jen-Luan Chen, Taipei (TW); Chih-Cho Shih, Tainan (TW); Chih-Yuan Chen, Tainan (TW)

Correspondence Address: BIRCH STEWART KOLASCH & BIRCH, PO BOX 747, FALLS CHURCH, VA, 22040-0747, US

(21) Appl. No.: 10/600,619

(22) Filed: Jun. 23, 2003

(30) Foreign Application Priority Data
Dec. 31, 2002 (TW) 91138130

(51) Int. Cl. H01M 8/10; C08J 5/22

(52) U.S. Cl. 429/33; 521/27

(57) ABSTRACT

Layered proton exchange membrane and method for preparing the same. The layered proton exchange membrane comprises an organic/inorganic composite membrane and at least one proton exchange membrane wherein the organic/inorganic composite membrane comprises inorganic proton conductors and an organic base polymer. The method comprises mixing inorganic proton conductors with an organic base polymer to form an organic/inorganic composite membrane, and combining the organic/inorganic composite membrane with at least one proton exchange membrane.

### BACKGROUND OF THE INVENTION

1. Field of the Invention

The present invention relates to a proton exchange membrane (PEM), and in particular to a proton exchange membrane used as a fuel selective permeation membrane for direct liquid-feed methanol fuel cells.

2. Description of the Related Art

In recent years, proton exchange membrane (PEM) has become an important material for applications in fuel cell membranes, electro-chemical reactors, and sensors. Nafion® (Perfluorocarbon Sulphonic Acid Polymer) developed by DuPont is the most applicable proton exchange membrane. However, it is not widely applicable as it has a high unit price of US$ 800˜1000/m². Moreover, the characteristics of Nafion® are unsuitable for use in direct liquid-feed methanol fuel cells. As a result, a substitute material for use as a proton exchange membrane is required.

A methanol-H₂O solution used as a fuel in direct liquid-feed methanol fuel cells (DMFC) reacts with a catalyst to produce electrons and protons in a anode. Electrons then enter the external circuit, and protons flow via a proton exchange membrane to the cathode (anode) to combine with oxygen and electrons from the external circuit to react and produce water. Currently, one obstacle to PEM use in DMFC is production of complex compounds generated by highly compatible molecules of methanol and water. Hydrogen ions (protons) are ions without electrons, i.e. naked protons. The lack of charge shields the nucleus, thus a proton strongly inter-reacts with its surroundings to form complex compounds. Consequently, methanol fuel used in DMFC easily combines with protons in the anode thereby passing the PEM, causing excessive fuel loss. At the same time, the catalyst and oxygen are consumed in the cathode, which poisons the catalyst, thus reducing activity in the cathode. This is the so-called “methanol crossover”, which is the major cause of poor efficiency in DMFC.

If PEM is highly proton conductive, its chemical structure becomes strongly hydrophilic, in this environment methanol becomes easily hydrated. Consequently, methanol crossover is noticeably increased. The only method of overcoming this problem is to reduce the hydrophilic nature of the structure or to reduce the volume of the highly hydrophilic PEM cluster. However, it is reported that when the PEM is less hydrophilic, proton conductivity decreases.

Therefore, it is critical for PEM used in DMFC to provide high proton conductivity and high selectivity of small molecules of methanol. In terms of chemical structures, reducing the permeability of methanol and increasing the proton conductivity are mutually contradictory. No single material is able to satisfy the above requirements.

Current methods to reduce permeability of methanol include the following. One method reduces the concentration of ionic groups of PEM or use materials other than PEM. Concentration of the ionic groups in PEM is an important factor determining the proton conductivity of PEM. However, a high concentration of ionic groups in PEM cluster structure causes methanol crossover. Therefore, some research uses different concentrations of ionic groups in PEM to form layered structures, or sulfonate PEM with polymers containing a benzene ring to control the concentration of ionic groups in the system to reduce methanol crossover. In order to obtain satisfactory proton conductivity, however, the system must be operated at high temperature. Otherwise, proton conductivity is reduced due to the reduction of methanol crossover. Related patents are U.S. Pat. Nos. 5,525,436, 5,716,727, 6,025,085, 6,099,988, 6,124,060 and 5,599,639, relate to the method of using heterocycles of imidazole to provide proton conductivity. However, these methods are more suitable for use in anhydrous and high temperature environments. U.S. Pat. No. 6,365,294 discloses a PEM with polyphosphazene as the base polymer. U.S. Pat. No. 6,444,343 discloses a thin film formed by crosslinking of polystyrene sulfonic acid (PSSA) and PVDF, which exhibits low crossover of methanol.

Another method reduces the volume of the hydrophilic groups of PEM. In early PEM research, in order to increase the water saturation of PEM when used at high temperature, or to reduce the hydroxide crossover, some research proposes a method of impregnating metal oxides in the clusters of PEM by simple synthetic reaction, or by direct mixing of metal oxides with PEM. By doing so, the stability of proton conductivity of PEM is enhanced at high temperature and fuel crossover is reduced. In recent years, some methods of reducing methanol crossover in DMFC have been disclosed. Experimental results have shown that methanol crossover is inhibited, but improvement in large scale applications is difficult. When volume of PEM clusters is reduced, transportation paths of protons are simultaneously reduced, resulting in reduced conductivity. Related patents are U.S. Pat. Nos. 4,687,715, 5,849,428, 5,919,583, 6,059,943, 5,795,796, and 6,447,943.

A third method changes the transportation mechanism of protons in PEM. Originally, protons are transported by ionic groups in PEM. In order to increase proton conductivity, proton hopping mechanism, as in solid acidic groups of inorganic substances is desired. However, it is difficult for organic material to obtain this characteristic. In addition, the workability of inorganic material to form films is intrinsically unfavorable when adopting this method. Inorganic material that exhibits high proton conductivity at room temperature is also limited. Furthermore, these materials are easily soluble in water, and thus have an unstable nature. Consequently, no obvious advancements are accomplished by this method. Related patents are U.S. Pat. Nos. 4,594,297, 4,380,575 and WO 9,852,243.

### SUMMARY OF THE INVENTION

Accordingly, an object of the invention is to provide a proton exchange membrane (PEM) that exhibits both high proton conductivity and high methanol selectivity and a method for preparing the same.

In order to achieve the above object, the invention provides a layered proton exchange membrane, prepared by lamination of an organic/inorganic composite membrane having high methanol selectivity and at least a proton exchange membrane having high proton conductivity. The structure of such a layered PEM is shown in FIG. 1, where 10 represents the organic/inorganic composite membrane, comprising an inorganic proton conductor 14 and an organic base polymer 16, and 12 represents the required proton exchange membrane.

Examples of inorganic filling materials, i.e. proton conductors suitable for this invention are H₃O⁺ β-alumina, Sb₂O₅*5.4H₂O, H-modenite, heteropoly acid, zeolite, zirconium phosphate, silicon oxide, titanium oxide, tungsten acid, sulfated zirconia, sulfated alumina, sulfated titanium oxide or sulfated titanium-aluminum oxide. At room temperature, proton conductivity is 10⁻²˜10⁻³S/cm, which is close to that of conventional PEM (5×10⁻²S/cm). If a thin film having this property is formed on a suitable base material, or the proton conductors are admixed with polymer to form a composite membrane, protons are transported by the solid acidic groups in the structure, and the interaction between methanol and protons is destroyed. As a result, methanol does not adhere to the protons and passes through PEM. The organic/inorganic composite membrane having high methanol selectivity is then laminated with a highly proton conductive PEM to obtain a layered proton exchange membrane having good proton conductivity.

In this invention, the organic base polymer is preferably polymer having proton conductivity; and the organic base polymer and base polymer of the proton exchange membrane are preferably polymers having cationic exchange groups. Examples of such polymer are polyvinylidenefluoride-grafted-polystyrene (PVDF-g-SPS), PVDF-g-Sulfonated-poly(N-vinylcarbazole), PVDF-g-poly(vinylphosphonic acid), PVDF-g-poly(4-vinylbenoic acid), PVDF-g-Sulfonated-poly(2-vinylnaphthalene), or PVDF-g-poly(9-vinylanthracene). The cationic exchange resins are preferably sulfonate, carboxylate, phosphonate, imide, sulfonimide or sulfonamide.

Optionally, fluorine-containing resin or non fluorine-containing resin is also added in the organic polymer base material to form composite membranes. Examples of fluorine-containing resins are poly(vinylidenefluoride), poly(vinylidenefluoride/hexafluoropropylene) copolymer, poly(vinylidenefluoride/chlorotrifluoroethylene) copolymer, poly(vinylidenefluoride/hexafluoropropylene/tetrafluoroet hylene) tripolymer or poly(chlorotrifluoro ethylene). Examples of non fluorine-containing resins are polyacrylate, polyester, polyetheretherketone, polysulfone, polyether, polyamide, polyphenylene oxide or polyethylene oxide. The above fluorine-containing resin or non fluorine-containing resins can be formed as films, followed by lamination with the organic base polymer.

According to the layered PEM provided in this invention, methanol crossover (permeability) of the organic/inorganic composite membrane is lower than 10⁻⁷ cm²/s and proton conductivity of organic/organic composite membrane is at least 10⁻⁴S/cm.

Another example of the layered proton exchange membrane is shown in FIG. 2, where more than one layer of proton exchange membranes 12 are laminated with the organic/inorganic composite membrane 10. It should be noted that the organic/inorganic composite membrane must be on one side of the entire structure.

According to another aspect of the invention, a method for forming the layered proton exchange membrane comprises the steps of: (a) forming an organic/inorganic composite membrane by doping inorganic proton conductor in organic base polymer; and (b) combining the organic/inorganic composite membrane and a proton exchange membrane to form a layered proton exchange membrane.

Step (a) is performed by physical mixing, chemical cross-linking, UV radiation cross-linking or sol-gel, and step (b) is performed by thermal pressing, chemical cross-linking or UV radiation cross-linking.

According to the above method, at least one proton exchange membrane laminated on the organic/inorganic composite membrane is located on one side of the layered proton exchange membrane. In step (b), an additional adhesive film can be added between the organic/inorganic composite membrane and the proton exchange membrane.

With the layered proton exchange membrane provided above, the invention also provides a direct liquid-feed methanol fuel cell, comprising: cathode; anode; and a layered proton exchange membrane, formed by lamination of an organic/inorganic composite membrane with at least one proton exchange membrane, wherein the organic/inorganic composite membrane comprises an organic base polymer and an inorganic proton conductor.

According to the proton exchange membrane of the invention, a conventional filling method using metal oxides (such as silicon oxide, zirconium oxide, titanium oxide) is replaced with proton conductors having high proton conductivity to replace the transportation mechanism of protons in original PEM ionic groups. Methanol crossover is then reduced and the proton conductors do not dissolve in water.

In this invention, the base polymer used by proton transportation is low-cost and is to fabricate and use in comparison to conventional a perfluoro polymer.

By applying the lamination technique with another PEM having high proton conductivity, proton conductivity is not reduced due to the introduction of inorganic substances. Non perfluoro polymer is used to laminate with other organic material to form composite membranes, so that methanol crossover is further reduced.

A detailed description is given in the following embodiments with reference to the accompanying tables.

### BRIEF DESCRIPTION OF THE DRAWINGS

The present invention can be more fully understood by reading the subsequent detailed description and examples with references made to the accompanying drawings, wherein:

FIG. 1 is cross section of a layered PEM.

FIG. 2 is cross section of another example of the layered proton exchange membrane according to the invention.

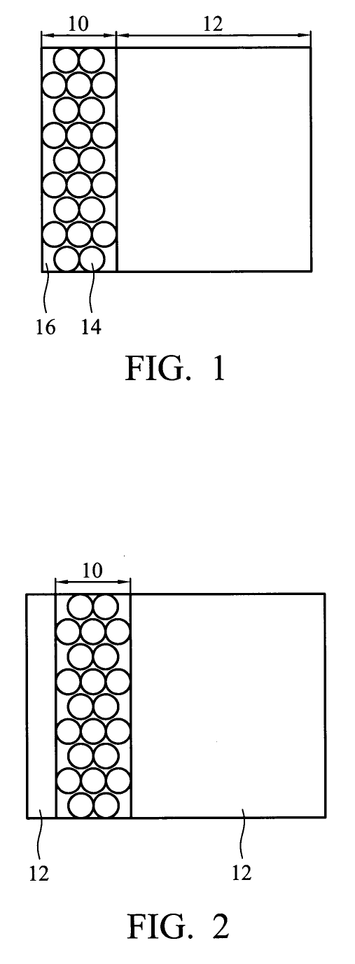

### DETAILED DESCRIPTION OF THE INVENTION

### EXAMPLES

### Example 1

40 g of styrene monomer (purity 99.9%) was added to 40 g of poly(vinylidenefluoride), followed by mixing evenly to obtain a mixture. Radiation by Co-60 was then carried out to induce grafting reaction, and the radiation dosage was 25 kGy.

PVDF-g-PS product was then extracted by Soxhlet extraction using chloroform to remove unreacted monomers and styrene homopolymer. White PVDF-g-PS was then obtained after heating or drying at room temperature. Grafting percentage varied with different reaction conditions in the range of 20˜100%. In this example, the grafting percentage was 62.4 wt %.

6.9 g of PVDF-g-PS and 12.5 g of poly(vinylidenefluoride) resin and 10 mg of fluoro surfactant FC-430 were then added to dissolve in 20 ml of 1-methyl-2-pyrrolidone to obtain a PVDF-g-PS solution.

H-form zeolite of 5 Phr was then added to the PVDF-g-PS solution for physical blending of 16 hours to complete blending. The cast film method was then used to form organic/inorganic composite membrane at 130° C.

Another two membranes of PVDF-g-PS (having different grafting percentages of 40 wt % and 80 wt %) were then thermal laminated with the organic/inorganic composite membrane to obtain laminated membranes.

Chlorosulfonic acid was then used for sulfonation at 25° C. Reaction duration varied with the thickness of membranes. In this example, it was 8 hrs. After sulfonation, tetrahydrofuran and water were then used to clean the membranes. Then, the membranes were dried in a vacuum for 6 hours at 80° C. to obtain layered proton exchange membrane. Conductivity, methanol crossover and ratio thereof were tested and listed in the following Table 1.

TABLE 1

| | | | | Conduc- |
|---|---|---|---|---|
| | | | | tivity/ |
| | | Conduc- | | permea- |
| | Thickness | tivity | Methanol | bility |
| | (μm) | (S/cm) | crossover | (C/P) |
| Nafion 117 | 195 | 1.50 × 10⁻² | 2.6 × 10⁻⁶ | 5770 |
| MRL424/(MRL279/ | 200 | 4.19 × 10⁻³ | 5.31 × 10⁻⁷ | 7890 |
| zeolite)/MRL425 | | | | |

Note:
Nafion 117 is a commercial proton exchange membrane;
MRL424, 425 represents PVDF-g-SPS having different grafting percentage;
MRL279/zeolite represents the organic/inorganic composite membrane obtained in this invention.

### Example 2

40 g of styrene monomer (purity 99.9%) was added to 40 g of poly(vinylidenefluoride) resin, followed by evenly mixing to obtain a mixture. Radiation by Co-60 was then carried out to induce a grafting reaction, and the radiation dosage was 25 kGy.

PVDF-g-PS product was then extracted by Soxhlet extraction using chloroform to remove unreacted monomers and styrene homopolymer. A white product PVDF-g-PS was then obtained after heating or drying at room temperature. Grafting percentage varied with reaction conditions in the range of 20˜100%. In this example, grafting percentage was 62.5%.

6.9 g of PVDF-g-PS and 12.5 g of poly(vinylidenefluoride) resin and 10 mg of fluoro surfactant FC-430 were then added to dissolve in 20 ml of 1-methyl-2-pyrrolidone.

H-form zeolite of 16 Phr was then added to the PVDF-g-PS solution for physical blending for 16 hours to complete blending. The cast film method was then used to form organic/inorganic composite membrane at 130° C.

Another Nafion (adhesive film) was then cast on the organic/inorganic composite membrane. Another layer of PVDF-g-PS having different grafting percentage (62.5 wt %) was then thermally laminated with the organic inorganic composite membrane to obtain a layered proton exchange membrane.

Next, chlorosulfonic acid was then used for sulfonation at 25° C. Reaction duration varied with membrane thickness. In this example, it was 8 hrs. After sulfonation, tetrahydrofuran and water were then used to clean the membranes. The membranes were then dried in a vacuum for 6 hours at 80° C. to obtain a layered proton exchange membrane. Conductivity, methanol crossover and ratio thereof were tested and listed in the following Table 2.

TABLE 2

| | | | | Conduc- |
|---|---|---|---|---|
| | | | | tivity/ |
| | | Conduc- | | permea- |
| | Thickness | tivity | Methanol | bility |
| | (μm) | (S/cm) | crossover | (C/P) |
| Nafion 117 | 195 | 1.50 × 10⁻² | 2.6 × 10⁻⁶ | 5770 |
| MRL424/(MRL279/ | 80 | 8.39 × 10⁻³ | 3.4 × 10⁻⁷ | 24700 |
| zeolite)/MRL425 | | | | |

Note:
Nafion 117 is a commercial proton exchange membrane;
MRL279/zeolite represents the organic/inorganic composite membrane obtained in this invention.

According to the layered proton exchange membrane and method for preparing the same, a PEM that exhibits both satisfactory proton conductivity and methanol crossover is obtained. In addition, polymer used in this invention costs less than conventional polymers.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A layered proton exchange membrane, comprising:
an organic/inorganic composite membrane, comprising inorganic proton conductor and organic base polymer; and
at least one proton exchange membrane.

2. The layered proton exchange membrane as claimed in claim 1, wherein the inorganic proton conductor is H₃O⁺ β-alumina, Sb₂O₅*5.4H₂O, H-modenite, heteropoly acid, zeolite, zirconium phosphate, silicon oxide, titanium oxide, tungsten acid, sulfated zirconia, sulfated alumina, sulfated titanium oxide or sulfated titanium-aluminum oxide.

3. The layered proton exchange membrane as claimed in claim 1, wherein the organic base polymer is a proton conductive polymer.

4. The layered proton exchange membrane as claimed in claim 1, wherein the organic base polymer and base material of the proton exchange membrane are polymers with cationic ion exchange groups.

5. The layered proton exchange membrane as claimed in claim 4, wherein the polymers with cationic ion exchange groups are poly(vinylidenefluoride)-grafted-sulfonatedpolystyrene (PVDF-g-SPS), PVDF-g-sulfonated-poly(N-vinylcarbazole), PVDF-g-poly(vinylphosphonic acid), PVDF-g-poly(4-vinylbenoic acid), PVDF-g-Sulfonated-poly(2-vinylnaphthalene), or PVDF-g-Sulfonated-poly(9-vinylanthracene).

6. The layered proton exchange membrane as claimed in claim 5, wherein the cationic ion exchange resins are sulfonate, carboxylate, phosphonate, imide, sulfonimide or sulfonamide.

7. The layered proton exchange membrane as claimed in claim 1, wherein the organic base polymer further comprises fluorine-containing resin to form the organic/inorganic composite membrane.

8. The layered proton exchange membrane as claimed in claim 7, wherein the fluorine-containing resin is poly(vinylidenefluoride), poly(vinylidenefluoride/hexafluoropropylene) copolymer, poly(vinylidenefluoride/chlorotrifluoroethylene)copolymer, poly(vinyilidenefluoride/hexafluoropropylene/tetrafluoroe thylene) tripolymer or poly(chlorotrifluoro ethylene).

9. The layered proton exchange membrane as claimed in claim 1, wherein the organic base polymer further comprises non fluorine-containing resin to form the organic/inorganic composite membrane.

10. The layered proton exchange membrane as claimed in claim 9, wherein the non fluorine-containing resin is polyacrylate, polyester, polyetherketone, polysulfone, polyether, polyamide, polyphenylene oxide or polyethylene oxide.

11. The layered proton exchange membrane as claimed in claim 1, wherein the methanol permeability of the organic/inorganic composite membrane is less than 10⁻⁷ cm²/s.

12. The layered proton exchange membrane as claimed in claim 1, wherein the proton conductivity of the organic/organic composite membrane is at least 10⁻⁴S/cm.

13. A method for preparing a layered proton exchange membrane, comprising of:
(a) forming an organic/inorganic composite membrane by doping inorganic proton conductor in organic base polymer; and
(b) combining the organic/inorganic complex membrane and a proton exchange membrane to form a layered proton exchange membrane.

14. The method as claimed in claim 13, wherein the step (a) is performed by physical blending, chemical cross-linking, UV radiation cross-linking or sol-gel.

15. The method as claimed in claim 13, wherein the step (b) is performed by thermal pressing, chemical cross-linking or UV radiation cross-linking.

16. The method as claimed in claim 13, wherein the number of the proton exchange membrane is at least one and the organic/inorganic composite membrane is located on one side of the layered proton exchange membrane.

17. The method as claimed in claim 13, wherein step (b) further comprises combining an adhesive film between the organic/inorganic composite membrane and the proton exchange membrane.

18. The method as claimed in claim 13, further comprising introducing cationic ion exchange groups into the layered proton exchange membrane.

19. A direct liquid-feed methanol fuel cell, comprising:
a cathode;
an anode; and
a layered proton exchange membrane, formed by lamination of an organic/inorganic composite membrane with at east one proton exchange membrane, wherein the organic/inorganic composite membrane comprises organic base polymer and inorganic proton conductor.

20. The direct methanol fuel cell as claimed in claim 19, wherein the methanol permeability of the organic/inorganic composite membrane is less than 10⁻⁷ cm²/s.

21. The direct methanol fuel cell as claimed in claim 19, wherein the proton conductivity of the organic/inorganic composite membrane is at least 10⁻⁴S/cm.
